(19) United States
(12) Patent Application Publication
(10) Pub. No.: US 2023/0196339 A1
(43) Pub. Date: Jun. 22, 2023

(54) SYSTEMS AND METHODS FOR FACILITATING VIRTUAL SPACE INSTANCE ACCESS AND CONTEMPORANEOUS STREAMING PAYMENTS

(71) Applicant: ARTFX META, INC, El Cajon, CA (US)

(72) Inventors: Joshua Drew James, El Cajon, CA (US); Calvin C. Schultz, Rockford, IL (US)

(21) Appl. No.: 17/556,292

(22) Filed: Dec. 20, 2021

(51) Int. Cl. G06Q 20/36; G06T 19/00; G06T 19/20; G06Q 20/38

(52) U.S. Cl. CPC G06Q 20/363; G06Q 20/389; G06T 19/003; G06T 19/20; G06T 2200/24; G06T 2219/024; G06T 2219/2016

(57) ABSTRACT

Systems and methods for facilitating virtual space instance access. Exemplary implementations may: obtain, in an ongoing manner, state space information defining a present state of a virtual space instance; facilitate presentation of a view of the virtual space instance to users through graphical user interfaces; obtain one or more consideration provision channels associated with one or more of the users; monitor the state space information for circumstances in the virtual space instance that satisfy circumstantial triggers of consideration stream trigger definitions associated with the objects; responsive to detection of circumstances in the virtual space instance that satisfy the circumstantial triggers, automatically initiate one or more streams of consideration amounts from one or more consideration provision channels to one or more consideration reception channels.

### FIELD OF THE DISCLOSURE

The present disclosure relates to systems and methods for facilitating virtual space instance access and contemporaneous streaming payments.

### BACKGROUND

Payment streaming within web applications may be enabled by static elements or engagement-based interactions with a programmable element. Peer to Peer (P2P) payment streaming may require more than one user to agree to terms so that a transaction may occur. A certifiable copy of that transaction may be stored on a nearimmutable ledger. Paying for objects on web applications may require interacting with a physical payment method or a digital payment method to input payment information into a transaction order before processing. A “point of sale” (PoS) may be a unique gateway for processing transactions that occur within a physical or digital space that must operate within a set of parameters defined by a merchant for a transaction to be considered successful.

### SUMMARY

Static Website Elements may store information about users based on their engagement within the website or with features of the website. P2P payment streaming may require payment paths that can be interoperate across jurisdictions without introducing semantic conflict. Information can be copied and moved off-ledger, or between ledgers. Large files of complex information may not be stored on distributed ledgers due to the size of the information leading to cost constraints. Traditional payments may encounter problems processing digital good-based transactions efficiently. Cryptologically secure payment systems have problems with reliability without introducing hidden costs associated with decentralized network transaction validation increasing power consumption loads. PoS gateways may be absent or underdeveloped in virtual spaces.

The present disclosure is related to a system of interactive digital objects that elicit sensory responses upon engagement with the digital objects that include information exchange required for digital transactions. Upon the engagement with the digital objects that include information that may be required for the digital transactions, a stream of consideration may be initiated from payment accounts associated with the users to the recipient accounts associated with the objects interacted with. As such, a network of peered decentralized users that function as accounts may be created where a recipient account and a payment account function interchangeably.

One aspect of the present disclosure relates to a system configured for facilitating virtual space instance access. The system may include one or more hardware processors configured by machine-readable instructions, and electronic storage. The machine-readable instructions may include one or more instruction components. The instruction components may include one or more of a virtual space component, a presentation component, a channel component, a stream component, and/or other instruction components.

The virtual space component may be configured to obtain state space information defining a present state of a virtual space instance that includes a simulated 3-dimensional topography, objects positioned within the topography and capable of locomotion within the topography, and expresses ongoing real-time interaction by one or more users. The state space information may be obtained in an ongoing manner. the state space information may include object definitions, object state information associated with the objects present in the virtual space instance, and/or other information. The object definitions for the individual objects define attributes, capabilities of the objects, and/or other object definitions for the individual objects. The object state information for the individual objects may specify the position, motion, actions, and/or other object state information of the objects within the virtual space instance.

By way of non-limiting illustration, the objects present in the virtual space instance may include a first object, a second object, and/or other objects. The first object may be associated with a first object definition. The first object definition may include a first streaming consideration reception profile for the first object. The first streaming consideration reception profile may include a first consideration stream trigger definition. The first consideration stream trigger definition may specify a first circumstantial trigger, a first consideration amount, a first consideration reception channel, and/or other information related to the consideration stream trigger. The second object may be associated with a second object definition similar to the first object definition.

The presentation component may be configured to facilitate presentation of a view of the virtual space instance to users through graphical user interfaces. For example, the users may include a first user, a second user, and/or other users. As such, the objects may be presented within the view of the virtual space instance in accordance with the obtained state space information.

In some implementations, multiple ones of the users may interact with a single object in the virtual space instance. In some implementations, the first user, for example, may interact with multiple ones of the objects in the virtual space instance. Thus, the channel component may be configured to obtain a first consideration provision channel associated with the user or, in some implementations, a plurality of consideration provision channels associated with the multiple users. For example, a second consideration provision channel and/or other consideration provision channel may be obtained.

The stream component may be configured to monitor the state space information for circumstances in the virtual space instance that satisfy the circumstantial trigger of the consideration stream trigger definition. In some implementations, where multiple users may interact with the first object, the stream component may be configured to automatically and contemporaneously initiate streams of the first consideration amount from the consideration provision channels to the first consideration reception channel. The automatic initiation may be responsive to detection of circumstances in the virtual space instance that satisfy the first circumstantial trigger of the first consideration stream trigger definition. In some implementations, where the first user interacts with the multiple objects, the stream component may be configured to automatically and contemporaneously initiate streams of the consideration amounts as defined by the object definitions to the respective consideration reception channels. For example, a stream of the first consideration amount from the first consideration provision channel to the first consideration reception channel may be initiated and a stream of a second consideration amount from the first consideration provision channel to a second consideration reception channel may be initiated.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for facilitating virtual space instance access, in accordance with one or more implementations.

FIG. 2 illustrates a method for facilitating virtual space instance access, in accordance with one or more implementations.

FIG. 3 illustrates an example implementation for facilitating virtual space instance access, in accordance with one or more implementations.

FIG. 4 illustrates an example implementation for facilitating virtual space instance access, in accordance with one or more implementations.

### DETAILED DESCRIPTION

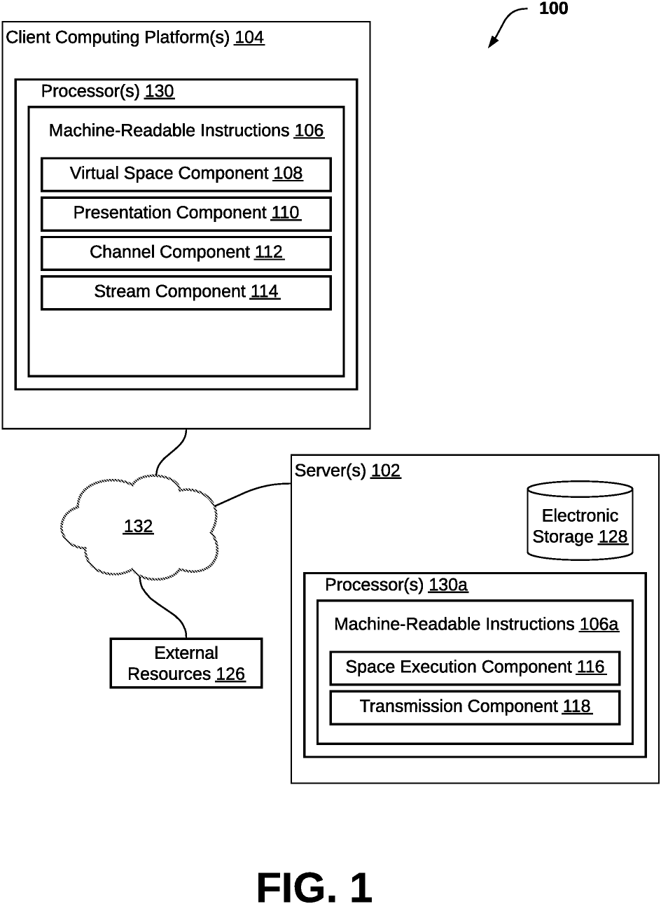

FIG. 1 illustrates a system 100 configured for facilitating virtual space instance access, in accordance with one or more implementations. In some implementations, system 100 may include one or more servers 102,client computing platform(s) 104, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Client computing platform(s) 104 may be configured by machine-readable instructions 106. Machine-readable instructions 106 may include one or more instruction components. The instruction components may include computer program components. The instruction components may include one or more of virtual space component 108, presentation component 110, channel component 112, stream component 114, and/or other instruction components.

Virtual space component 108 may be configured to obtain state space information defining a present state of a virtual space instance that includes a simulated 3-dimensional topography, objects positioned within the topography and capable of locomotion within the topography, expresses ongoing real-time interaction by one or more users, and/or other state space information. The state space information may be obtained in an ongoing manner. The term “ongoing manner” as used herein may refer to continuing to perform an action (e.g., obtaining, monitoring) periodically (e.g., every 30 seconds, every minute, every hour, etc.) until receipt of an indication to terminate. The indication to terminate may include powering off client computing platform 104, terminating an Internet connection for client computing platform 104, refreshing client computing platform 104, and/or other indications of termination.

The state of the virtual space defined by the state space information may be communicated (e.g., via streaming, via object/position data, and/or other information) from server(s) 102 and/or sources to client computing platforms 104 for presentation to users. The state determined and transmitted to a given client computing platform 104 may correspond to a location in the virtual space (e.g., the location from which the view is taken, the location the view depicts, and/or other locations), a view for a user character being controlled by a user via a given client computing platform 104, a zoom ratio, a dimensionality of objects, a point-of-view, and/or view parameters related to a view of the virtual space. One or more of the view parameters may be selectable by the user.

The virtual space instance may comprise a simulated space that is accessible by users via a web browser (on client computing platform(s) 104) that present the views of the virtual space to a user. The virtual space instance may assessable across multiple unique interoperable platforms, viewed offline within the web browser, and/or accessible in other manners. Web browsers may obtain the state space information and render the virtual space instance based on such. In some implementations, the state space information may be obtained from one or more servers, such as server(s) 102 described herein. In some implementations, the state space information may not require obtained from the one or more servers, but may instead obtain state space information from a software developer repository.

In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance executed by the computer components may be synchronous, asynchronous, and/or semi-synchronous.

The above description of the manner in which views of the virtual space are provided is not intended to be limiting. The virtual space may be expressed in a more limited, or richer, manner. For example, views determined for the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space, users may control characters, objects, simulated physical phenomena (e.g., wind, rain, earthquakes, and/or other phenomena), and/or other elements within the virtual space to interact with the virtual space and/or each other. The user characters may include avatars. As used herein, the term “user character” may refer to an object (or group of objects) present in the virtual space that corresponds to an individual user. The user character may be controlled by the user with which it is associated.

User-controlled element(s), such as the user characters, may move through and interact with the virtual space (e.g., non-user characters in the virtual space, other objects in the virtual space). The user-controlled elements controlled by and/or associated with a given user may be created and/or customized by the given user. The user may have an “inventory” of virtual goods and/or currency (e.g., resources of the plurality of resource types) that the user can use (e.g., by manipulation of a user character or other user-controlled element, and/or other items) to perform actions within the virtual space.

The users may participate in the instance of the virtual space by controlling one or more of the available user-controlled elements in the virtual space. Control may be exercised through control inputs and/or commands input by the users through client computing platforms 104. In some implementations, the users may interact with each other through communications exchanged within the virtual space. Such communications may include one or more of textual chat, instant messages, private messages, voice communications, and/or other communications. Communications may be received and entered by the users via their respective client computing platforms 104. Communications may be routed to and from the appropriate users through server(s) 102.

In some implementations, elements of the virtual space instance may be customized and/or defined by the individual users. For example, the users may define the topography, the characters present, the objects present, the simulated physical phenomena, and/or other elements within the instance of the virtual space. In some implementations, the users may have access to one or more pre-defined instances of the virtual space. In some implementations, the one or more pre-defined instances may be customizable or fixed. In some implementations, the one or more pre-defined instances may be created and shared by other ones of the users.

The state space information may include object definitions, object state information associated with the objects present in the virtual space instance, and/or other information. The object definitions for individual ones of the objects may define attributes, capabilities of the objects, social media information, a streaming consideration reception profile, and/or other object definitions for the individual objects. The attributes may include values to attribute parameters that define an appearance, a size, a weight, a height, and/or other attributes of the objects. The appearance may include accessories (e.g., a hat, glasses, jewelry, gloves, shoes, etc.), clothing (e.g., shirt, pants, a dress, etc.), skin, and/or other appearances. The values to the attribute parameters that define the appearance may include one or more values to a color, a texture, a pattern, and/or other attribute parameters related to the appearance. The values to the attribute parameters that define the size may include values to an X-scale, Y-scale, Z-scale, and/or other attributes parameters related to the size. The values to the attribute parameters that define the weight and the height may include values to a length of the object or portions thereof, a width of the object or portions thereof, and/or other attribute parameters related to the weight and the height.

The capabilities of the objects may include values to capability parameters. The capability parameters may include a speed, a strength, potential actions, an orientation limitation, displacement limitation, content for presentation (e.g., image, video, audio), a playback speed, and/or other capabilities of the object. The value to the speed may be a speed at which the object may run, walk, be thrown, roll, talk, and/or other speeds. The value to the strength may define how much the object may hold, pick up, pick up and subsequently throw, twist, and/or other strengths. The values to the potential actions may include presenting individual content, facilitating a modification to another object, a displacement, a motion, providing means of communication, purchasing an item, and/or other potential actions. The means of communication may include one or more of a textual chat, instant messages, private messages, voice communications, video communications, in-game communication, out-of-game communication, hybrid communication (e.g., in-browser and out-of-browser), and/or other means of communication.

The orientation limitation may be defined by values to a roll angle, a yaw angle, a pitch angle. The displacement limitation may be defined by a value to a unit of measurement. The unit of measurement may include inches, feet, millimeters, centimeters, meters, and/or other units of measurement within the instance of the virtual space.

The content for presentation that may be potentially presented may include one or more images, videos, informational text, audio, a website page, an online shopping cart page, game content, and/or other content. The individual content may be associated with content information. The content information for the individual content may include a content description, a content creator, a content creation date, a content name, and/or content copyrights, and/or other content information. The game content may include a task, a quest, an assignment, a mission, a level, a chapter, a mini-game, a virtual item, a virtual resource (e.g., weapon, tool), of in-game powers, in-game skills, in-game technologies, and/or other pieces of game content. By way of non-limiting example, virtual items may include one or more of clothing, accessories, pets, transportation units (e.g., aircrafts, motor vehicles, watercrafts, etc.), units, buildings, and/or other virtual items. The social media information may include one or more social media pages, a view amount of the one or more social media pages, an amount of followers of the one or more social media pages, demographic information of the followers and viewers (e.g., age, race, ethnicity, country, etc.), and/or other social media information. The modifications to other ones of the objects may include, by way of non-limiting example, changes to the object definitions or particularly to the appearance of the objects. The object definitions that define the objects described herein are for exemplary purposes only and are not intended to be limiting.

The object state information for the individual objects may specify a position, an orientation, a motion, one or more actions, and/or other object state information of the objects within the virtual space instance. The object state information may be specific to a particular point in time within the virtual space instance. The position may be defined by XYZ coordinate values within the virtual space. The orientation may include values to the roll angle, the yaw angle, and/or the pitch angle. The motion may be defined by values to a speed, heading, and/or other motion parameters that convey that the objects are running, walking, spinning, jumping, flashing, shaking, and/or other motions. The actions may include one or more of the values to the potential actions or other actions that the object is currently executing.

By way of non-limiting illustration, the objects present in the virtual space instance may include a first object, a second object, and/or other objects. The first object may be associated with a first object definition. The second object may be associated with a second object definition. In some implementations, the objects may include user-controlled objects that are controlled by the users. For example, a third object may be a user character or an avatar for a given user.

The streaming consideration reception profile for the individual objects may include a consideration stream trigger definition and/or other information. The consideration stream trigger definition may specify a circumstantial trigger, a consideration amount, a consideration reception channel, and/or other information related to initiating consideration streams. The circumstantial trigger may specify one or more interactions with the respective object by the user that initiates a stream of the consideration amount upon occurrence. The consideration amount may specify a consideration type, a value in the consideration type, and/or other information related to the consideration amount. The consideration type may be a traditional consideration (e.g., US Dollars, Euros, GB Pounds, etc.), a cryptocurrency (e.g., Bitcoin, Ether, etc.), and/or other consideration type. For example, the consideration amount included in the consideration stream trigger definition may be 1 Bitcoin, 0.50 US Dollar, or 3 Euros.

The one or more interactions may include, by way of non-limiting example, viewing the object, a point of view of the user within the virtual space instance being in proximity to the object, rotating the object, shaking the object (e.g., up, down, left, right), displacing the object a particular distance, selecting the object, selecting a particular part of the object, altering the appearance of the object, throwing or shooting one or more other objects at the object, and/or interactions. By way of non-limiting illustration, the one or more interactions may be between the user or the point of view of the user, and the first object. In some implementations, the interactions between the user/the point of view of the user and the first object may be via cursor or pointer. In some implementations, the one or more interactions with the first object and/or other objects may be completed by the third object that is user-controlled. In some implementations, the consideration stream trigger definition may include more than one interaction that may initiate a stream of consideration. In some implementations, a particular interaction may be associated with a particular consideration amount.

The consideration stream trigger definition may include a distance value that specifies the proximity to the respective object that facilitates initiating the stream of the consideration amount upon occurrence. For example, the distance value may specify a distance between the point of view of the user and the respective object. As another example, the distance value may specify a distance between the respective object and the third object that is controlled by the user. The consideration reception channel may include one or more digital wallets that correspond to one or more addresses on a decentralized ledger, a bank account with a bank, a credit line with the bank, or other source/destination. The consideration reception channel, i.e., one or more digital wallets, may receive the stream of the consideration amount. The one or more digital wallets may be associated with one or more other ones of the users, one or more companies, one or more developers (i.e., non-user of the virtual space instance), and/or other entities.

For example, the first object definition may include a first streaming consideration reception profile for the first object and/or other information. The first streaming consideration reception profile may include a first consideration stream trigger definition and/or other information. The first consideration stream trigger definition may specify a first circumstantial trigger, a first consideration amount, a first consideration reception channel, and/or other information. The first consideration reception channel may include a first digital wallet that corresponds to a first address on the decentralized ledger. A second object definition may include a second streaming consideration reception profile for the second object and/or other information. The second streaming consideration reception profile may include a second consideration stream trigger definition and/or other information. The second consideration stream trigger definition may specify a second circumstantial trigger, a second consideration amount, a second consideration reception channel, and/or other information. The second consideration reception channel, included in the second object definition, may include a fourth digital wallet that corresponds to a fourth address on the decentralized ledger.

Presentation component 110 may be configured to facilitate presentation of a view of the virtual space instance to users through individual graphical user interfaces. The users may include a first user, a second user, and/or other users. As such, the objects may be presented within the view of the virtual space instance in accordance with the obtained state space information. Based on the state space information, the graphical user interfaces may present the simulated 3-dimensional topography, the objects positioned or moving within the topography, and/or other elements within the virtual space. The view of the virtual space instance may be presented in an ongoing manner in accordance with the ongoing obtainment of the state space information.

In some implementations, a plurality of users may interact with the same object, such as the first object. Thus, streams of the first consideration amount from a plurality of consideration provision channels associated with the plurality of the users to the first consideration reception channel may be initiated upon occurrence of the first circumstantial trigger by a plurality of the users or user-controlled objects thereof.

In some implementations, individual users, such as the first user, may interact with a plurality of the objects at once. Thus, for example, streams of various consideration amounts (specified by the object definitions of the plurality of the objects) from a consideration provision channel to various consideration reception channels associated with the objects that the first user interacted with may be initiated upon occurrence of the interactions that satisfy the circumstantial triggers of the objects.

In some implementations, where a plurality of users may interact with the same object, channel component 112 may be configured to obtain the consideration provision channels associated with the users. Individual ones of the consideration provision channels associated with individual ones of the users may include a user digital wallet that corresponds an address on the decentralized ledger, a bank account with a bank, a credit line with the bank, or other source. The individual consideration provision channels may specify the consideration type of the consideration that the individual consideration provision channels may hold and/or transfer. As such, many streams, or transfers, of the first consideration amount may occur from a plurality of the users (i.e., the associated consideration provisional channels) to the first consideration reception channel.

By way of non-limiting illustration, the consideration provision channels may include a first consideration provision channel, a second consideration provision channel, and/or other consideration provisional channels. The first consideration provision channel may be associated with the first user and the second consideration provision channel may be associated with the second user. The first consideration provision channel may include a second digital wallet. The second consideration provision channel may include a third digital wallet. The second digital wallet may correspond to a second address on the decentralized ledger, and the third digital wallet may correspond to a third address on the decentralized ledger.

In some implementations, channel component 112 may be configured to determine intermediate consideration channels that facilitate providing the consideration amount, respective to the streaming consideration reception profile, from individual ones of the consideration provision channels to the respective consideration reception channels. For example, determining the intermediate consideration channels may be based on the first consideration reception channel and the individual consideration provision channels (e.g., the first consideration provision channel and the second consideration provision channel, individually). In some implementations, determining the intermediate consideration channels may be based on the respective streaming consideration reception profile and the consideration provision channels, and/or other information. Individual ones of the intermediate consideration channels may include a wire transfer, a bank-to-bank transfer, Interledger protocol, and/or other intermediate consideration channels. For example, upon the consideration provisional channels including a first bank account and the first consideration reception channel including a second bank account, a first intermediate consideration channel may be a bank-to-bank transfer. Furthermore, based on the individual consideration provision channels and the first consideration reception channel, the first consideration amount may be appropriately converted to the consideration type defined by the first consideration stream trigger definition from the consideration type included in the individual consideration provision channels.

In some implementations, channel component 112 may be configured to determine whether the individual consideration provision channels are connected. The connection may be between the consideration provision channels and the web browser of client computing platforms 104 the users are using to interact with the virtual space instance. Upon determination that the consideration provision channels are connected, channel component 112 may be configured to determine whether the consideration provision channels indicate that consideration is available. In particular, the consideration provision channels may indicate whether the corresponding digital wallets includes the consideration. In some implementations, channel component 112 may be configured to determine whether a particular amount of consideration is available. In some implementations, the object definitions may define one or more adjustments to the attributes and/or the capabilities responsive to unavailability of consideration as indicated by the consideration provision channels. That is, the objects present in the virtual space instance may be adjusted to be presented differently than upon availability of the consideration. Upon determination that the consideration provision channels are not connected or upon determination that the consideration is not available, channel component 112 may be configured to determine the one or more adjustments to the attributes and/or the capabilities of the objects in accordance with the object definitions. For example, some objects in the virtual space instance may not be present, may appear differently (e.g., dull colors, smaller), or may have adjusted or less capabilities (e.g., cannot present content, cannot be selected, cannot be picked up), or other adjustments.

Stream component 114 may be configured to monitor the state space information for circumstances in the virtual space instance that satisfy the first circumstantial trigger of the first consideration stream trigger definition. The state space information may be monitored in an ongoing manner as the state space information is obtained in an ongoing manner. The state space information may be monitored for circumstances specific to the individual objects and that involve the individual objects accordingly. Occurrences of circumstances that are unrelated to the individual objects may not satisfy the circumstantial trigger the individual objects are associated with. For example, upon displacement of a given object by the user, which is satisfaction of a circumstantial trigger for the given object to initiate a stream of a given consideration amount, the first circumstantial trigger for the first object may not be satisfied because such displacement does not involve the first object.

In some implementations, monitoring the state space information for circumstances in the virtual space instance that satisfy a given circumstantial trigger may include comparing the values to the parameters defined in the state space information (e.g., the object state information) with the given circumstantial trigger. In some implementations, monitoring the state space information for circumstances in the virtual space instance that satisfy the distance value may include calculating a current distance between the given object, such as the first object, and the users or the user-controlled objects and compare the current distance to the distance to determine if they are equal. The calculation of the current distance may be ((xᵤₛₑᵣ – x_{first} _{object})² + (yᵤₛₑᵣ –y_{first} _{object})² + (zᵤₛₑᵣ - z_{first} _{object})²)^{½}. In some implementations, a distance of displacement may be determined. In some implementations, monitoring the state space information may be facilitated by machine learning techniques.

Stream component 114 may be configured to automatically initiate streams of the first consideration amount from the consideration provision channels to the first consideration reception channel. The streams may be initiated contemporaneously. The automatic initiation may be responsive to detection of circumstances in the virtual space instance that satisfy the circumstantial trigger of the consideration stream trigger definition. For example, the streams of the first consideration amount may be a transfer or a payment of the first consideration amount from the first consideration provision channel to the first consideration reception channel, and from the second consideration provision channel to the first consideration reception channel. In some implementations, the individual streams may refer to incremental transfers of the first consideration amount that occur at time increments (e.g., every 10 seconds) and while the circumstance that satisfies the circumstance trigger is occurring. The time increments at which the first consideration amount may be streamed may be included in the first consideration stream trigger definition. In some implementations, the time increments may be defined by system 100 and fixed. In some implementations, the individual streams may refer to a single transfer of the first consideration amount. In some implementations, the individual streams may refer to incremental transfers of the fixed consideration amount and an amount of time the one or more interactions occurred over.

In some implementations, where individual users may interact with a plurality of the objects at once, channel component 112 may be configured to obtain the first consideration provision channel associated with the first user. In some implementations, channel component 112 may be configured to determine intermediate consideration channels that facilitates providing the consideration amounts, respective to the consideration reception channels, from the first consideration provision channel to the consideration reception channels. Determining the intermediate consideration channels may be based on the individual consideration reception channels and the consideration provision channel associated with the user interacting with the plurality objects. For example, the first intermediate consideration channel may be determined based on the first consideration provision channel and the first consideration reception channel associated with the first object, and a second intermediate consideration channel may be determined based on the first consideration provision channel and the second consideration reception channel associated with the second object.

In some implementations, stream component 114 may be configured to monitor the state space information, as described herein, for circumstances in the virtual space instance that satisfy the circumstantial triggers of the consideration stream trigger definitions specified by the object definitions. That is, the state space information may be monitored for circumstances that satisfy the first circumstantial trigger included the first object definition and the second circumstantial trigger included in the second object definition.

In some implementations, stream component 114 may be configured to automatically and contemporaneously initiate streams of the consideration amounts specified by the object definitions from the first consideration provision channel to the consideration reception channels specified by the object definitions. That is, the first consideration amount may be streamed to the first consideration reception channel from the first consideration provision channel, and the second consideration amount may be streamed to the second consideration reception channel from the first consideration provision channel. The automatic initiations may be responsive to detection of circumstances in the virtual space instance that satisfy the circumstantial triggers, such as the first circumstantial trigger and the second circumstantial trigger.

In some implementations, server(s) 102 may be configured by machine-readable instructions 106a. Machine-readable instructions 106a may include one or more instruction components. The instruction components may include computer program components. The instruction components may include one or more of space execution component 116, transmission component 118, and/or other instruction components. Processor(s) 130a may be configured to provide information processing capabilities similar to processor(s) 130 as described herein, but in server(s) 102.

Space execution component 116 may be configured to execute the virtual space instance that includes a simulated 3-dimensional topography, objects positioned within the topography and capable of locomotion within the topography, and expresses ongoing real-time interaction by one or more users. Such execution may generate, in an ongoing manner, the state space information defining the present state of the virtual space instance.

Transmission component 118 may be configured to effectuate transmission of the state information to client computing platform 104 associated the user and/or the web browser. Such transmission may facilitate presentation of the view of the virtual space instance to the user through the graphical user interface of client computing platform 104. As such, the objects, such as the first object, may be presented within the view of the virtual space instance in accordance with the obtained state space information.

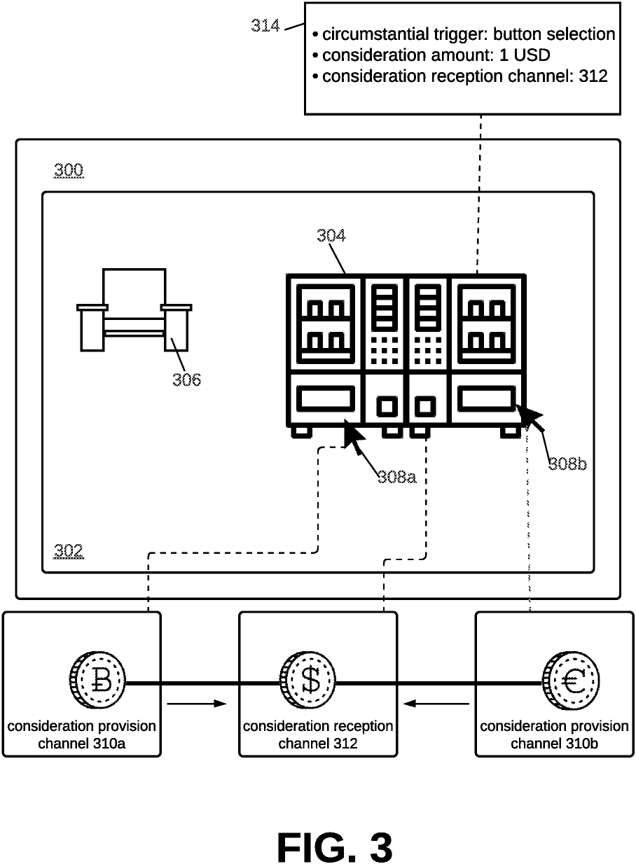

FIG. 3 illustrates an example implementation for facilitating virtual space instance access, in accordance with one or more implementations. FIG. 3 illustrates a virtual space instance 302 presented by a browser 300. Browser 300 may be configured to obtain state space information that facilitates the presentation of virtual space instance 302. Virtual space instance 302 may include a first object 304, a second object 306, and cursors 308a and 308b. Cursor 308a may be controlled by a first user and/or represent the first user. Cursor 308b may be controlled by a second user and/or represent the second user. Browser 300 may establish a connection with a consideration provision channel 310a and consideration provision channel 310b. Consideration provision channel 310a may be associated with the first user and correspond to a first digital wallet on a decentralized ledger that holds consideration (e.g., Bitcoin). Consideration provision channel 310b may be associated with the second user and correspond to a second digital wallet on a decentralized ledger that holds consideration (e.g., Euros). Consideration reception channel 312 may be associated with one or more other users, one or more companies, or other entity that may receive and hold consideration. Consideration reception channel 312 may correspond with a third digital wallet on the decentralized ledger. First object 304 and second object 306 may be associated with object definitions that include consideration stream trigger definitions. That is, first object 304 may be associated with a first object definition that includes a consideration stream trigger definition 314. Consideration stream trigger definition 314 may include values to a circumstantial trigger, a consideration amount, and a consideration reception channel. The value to the circumstantial trigger may initiate, upon occurrence, a stream of the value to the consideration amount to the value of the consideration reception channel. That is, responsive the first user and the second user selecting buttons on first object 304 with cursors 308a and 308b, a stream of 1 USD (i.e., the consideration) may be initiated from both consideration provision channel 310a and 310b to consideration reception channel 312.

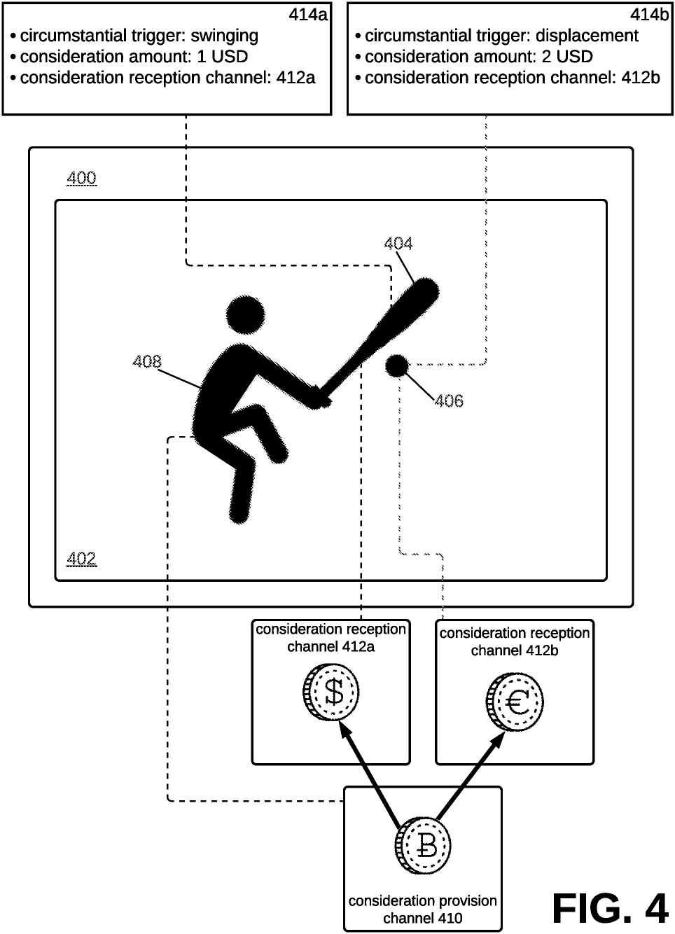

FIG. 4 illustrates an example implementation for facilitating virtual space instance access, in accordance with one or more implementations. FIG. 4 illustrates a virtual space instance 402 presented by a browser 400. Browser 400 may be configured to obtain state space information that facilitates the presentation of virtual space instance 402. Virtual space instance 402 may include a first object 404 (e.g., a bat), a second object 406 (e.g., a ball), and a player 408. Player 408 may be controlled by a first user and/or represent the first user. Browser 400 may establish a connection with a consideration provision channel 410. Consideration provision channel 410 may be associated with the first user and correspond to a first digital wallet on a decentralized ledger that holds consideration (e.g., Bitcoin). The first user, and thus player 408, may be associated with consideration provision channel 410a. Consideration reception channel 412a and consideration reception channel 412b may individually be associated with one or more different users, companies, or other entity that may receive and hold consideration. Consideration reception channel 412a may correspond with a second digital wallet on the decentralized ledger. Consideration reception channel 412b may correspond with a third digital wallet on the decentralized ledger. First object 404 and second object 406 may be associated with object definitions that include consideration stream trigger definitions. That is, first object 404 may be associated with a first object definition that includes a consideration stream trigger definition 414a. Second object 406 may be associated with a second object definition that includes a consideration stream trigger definition 414b. Consideration stream trigger definition 414a and consideration stream trigger definition 414b may include various values to a circumstantial trigger, a consideration amount, and a consideration reception channel. The value to the circumstantial trigger may initiate, upon occurrence, a stream of the values to the consideration amount to the values of the consideration reception channel. That is, responsive the first user swinging with first object 404 to hit and displace second object 406, a stream of 1 USD (i.e., the consideration amount associated with first object 404) may be initiated from consideration provision channel 410 to consideration reception channel 412a and a stream of 2 USD (i.e., the consideration amount associated with second object 406) may be initiated from consideration provision channel 410 to consideration reception channel 412b.

Referring to FIG. 1, in some implementations, server(s) 102, client computing platform(s) 104, and/or external resources 126 may be operatively linked via one or more electronic communication links. For example, such electronic communication links may be established, at least in part, via a network 132 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Client computing platform(s) 104 may include one or more processors 130a, and/or other components. Server(s) 102 may include electronic storage 128, one or more processors 130a, and/or other components. Server(s) 102 and/or client computing platform(s) 104 may include communication lines, or ports to enable the exchange of information with a network (e.g., network 132) and/or other computing platforms. Illustration of server(s) 102 in FIG. 1 is not intended to be limiting. Server(s) 102 and/or client computing platform(s) 104 may include a plurality of hardware, software, and/or firmware components operating together to provide the functionality attributed herein to server(s) 102 and/or client computing platform(s) 104. For example, server(s) 102 and/or client computing platform(s) 104 may be implemented by a cloud of computing platforms operating together as server(s) 102 and/or client computing platform(s) 104.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, and/or 118, and/or other components. Processor(s) 130 may be configured to execute components 108, 110, 112, 114, 116, and/or 118, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and/or 118 are illustrated in FIG. 1 as being implemented within a single processing unit, in implementations in which processor(s) 130 includes multiple processing units, one or more of components 108, 110, 112, 114, 116, and/or 118 may be implemented remotely from the other components. The description of the functionality provided by the different components 108, 110, 112, 114, 116, and/or 118 described below is for illustrative purposes, and is not intended to be limiting, as any of components 108, 110, 112, 114, 116, and/or 118 may provide more or less functionality than is described. For example, one or more of components 108, 110, 112, 114, 116, and/or 118 may be eliminated, and some or all of its functionality may be provided by other ones of components 108, 110, 112, 114, 116, and/or 118. As another example, processor(s) 130 may be configured to execute one or more additional components that may perform some or all of the functionality attributed below to one of components 108, 110, 112, 114, 116, and/or 118.

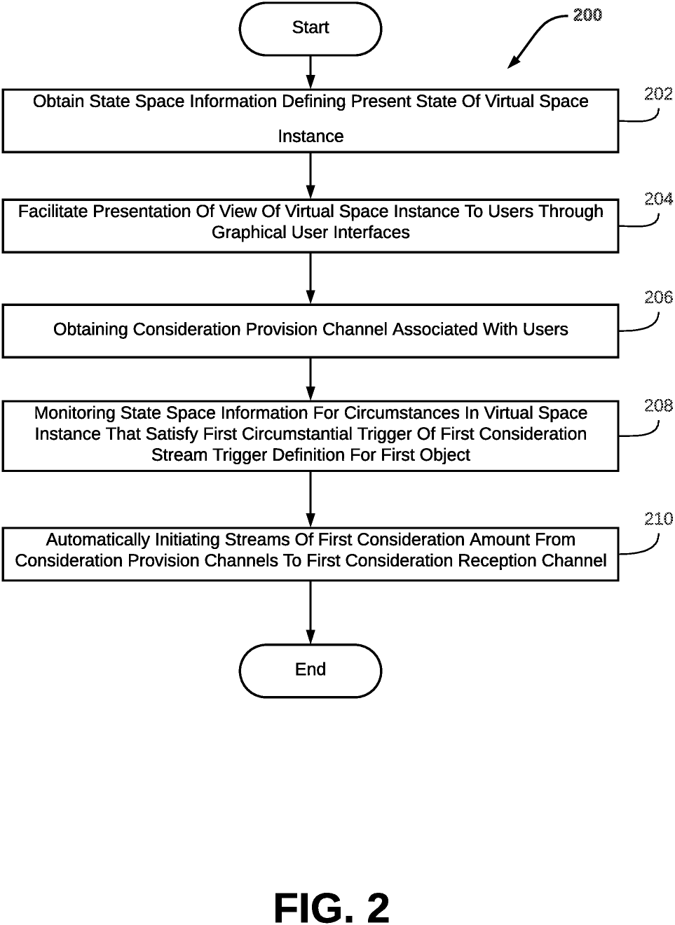

FIG. 2 illustrates a method 200 for facilitating virtual space instance access, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining state space information defining a present state of a virtual space instance that includes a simulated 3-dimensional topography, objects positioned within the topography and capable of locomotion within the topography, and expresses ongoing real-time interaction by one or more users. The state space information may be obtained in an ongoing manner. The state space information may include object definitions, object state information associated with the objects present in the virtual space instance, and/or other information. Operation 202 may be performed by one or more hardware processors configured by machine-readable instructions including a component that is the same as or similar to virtual space component 108, in accordance with one or more implementations.

An operation 204 may include to facilitating presentation of a view of the virtual space instance to users through graphical user interfaces. As such, the objects, such as a first object, may be presented within the view of the virtual space instance in accordance with the obtained state space information. Operation 204 may be performed by one or more hardware processors configured by machine-readable instructions including a component that is the same as or similar to presentation component 110, in accordance with one or more implementations.

An operation 206 may include obtaining consideration provision channels associated with the users. Operation 206 may be performed by one or more hardware processors configured by machine-readable instructions including a component that is the same as or similar to channel component 112, in accordance with one or more implementations.

An operation 208 may include monitoring the state space information for circumstances in the virtual space instance that satisfy a first circumstantial trigger of a first consideration stream trigger definition for the first object. Operation 208 may be performed by one or more hardware processors configured by machine-readable instructions including a component that is the same as or similar to stream component 114, in accordance with one or more implementations.

An operation 210 may automatically initiating streams of a first consideration amount from the consideration provision channels to a first consideration reception channel. The automatic initiation may be responsive to detection of circumstances in the virtual space instance that satisfy the first circumstantial trigger of the first consideration stream trigger definition for the first object. Operation 210 may be performed by one or more hardware processors configured by machine-readable instructions including a component that is the same as or similar to stream component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to facilitate virtual space instance access, the system comprising:
one or more client computing platforms configured by machine-readable instructions to:
obtain, in an ongoing manner, state space information defining a present state of a virtual space instance that includes a simulated 3-dimensional topography, objects positioned within the topography and capable of locomotion within the topography, and expresses ongoing real-time interaction by one or more users, the state space information including object definitions and object state information associated with the objects present in the virtual space instance, wherein the object definitions for the individual objects define attributes and/or capabilities of the objects, and the object state information for the individual objects specify a position, a motion, and/or actions of the objects within the virtual space instance,
wherein the objects present in the virtual space instance include a first object,
wherein the first object is associated with a first object definition, the first object definition including a first streaming consideration reception profile for the first object, the first streaming consideration reception profile including a first consideration stream trigger definition, the first consideration stream trigger definition specifying a first circumstantial trigger, a first consideration amount, and a first consideration reception channel;
facilitate presentation of a view of the virtual space instance to users through individual graphical user interfaces such that the objects are presented within the view of the virtual space instance in accordance with the obtained state space information;
obtain consideration provision channels associated with the users, wherein the users include at least a first user and a second user, and a first consideration provision channel is associated with the first user and a second consideration provision channel is associated with the second user;
monitor the state space information for circumstances in the virtual space instance that satisfy the first circumstantial trigger of the first consideration stream trigger definition; and
responsive to detection of circumstances in the virtual space instance that satisfy the first circumstantial trigger of the first consideration stream trigger definition, automatically initiate streams of the first consideration amount from the consideration provision channels associated with the users involved in the circumstances to the first consideration reception channel such that the first consideration amount is streamed from the first consideration provision channel and the second consideration provision channel to the first consideration reception channel.

2. The system of claim 1, wherein the first circumstantial trigger specifies one or more interactions with the object by the users that initiates the stream of the consideration amount upon occurrence.

3. The system of claim 2, wherein the one or more interactions include viewing the first object, a point of view of the user within the virtual space instance being in proximity to the first object, rotating the first object, displacing the first object, selecting the first object, and/or altering an appearance of the first object.

4. The system of claim 3, wherein the objects present in the virtual space instance include user-controlled objects that are controlled by the users, and wherein the one or more interactions with the first object are completed by the user-controlled objects.

5. The system of claim 1, wherein the first consideration provision channel includes a second digital wallet associated with the first user, and the second consideration provision channel includes a third digital wallet associated with the second user, wherein the second digital wallet corresponds to a second address on a decentralized ledger, and the third digital wallet corresponds to a third address on the decentralized ledger.

6. The system of claim 1, wherein the one or more client computing platforms are further configured by the machine-readable instructions to:
determine, based on the first consideration reception channel and the consideration provision channels, intermediate consideration channels that facilitates providing the first consideration amount from the consideration provision channels to the first consideration reception channel.

7. The system of claim 1, wherein the object definitions define one or more adjustments to the attributes and/or the capabilities responsive to unavailability of consideration as indicated by the consideration provision channels, wherein the one or more client computing platforms are further configured by the machine-readable instructions to:
determine whether the consideration provision channels are connected;
upon determination that the consideration provision channels are connected, determine whether the consideration provision channels indicate that consideration is available;
upon determination that the consideration provision channels are not connected or upon determination that the consideration is not available, determine the one or more adjustments to the attributes and/or the capabilities of the objects in accordance with the object definitions.

8. A system configured to facilitate virtual space instance access, the system comprising:
one or more client computing platforms configured by machine-readable instructions to:
obtain, in an ongoing manner, state space information defining a present state of a virtual space instance that includes a simulated 3-dimensional topography, objects positioned within the topography and capable of locomotion within the topography, and expresses ongoing real-time interaction by one or more users, the state space information including object definitions and object state information associated with the objects present in the virtual space instance, wherein the object definitions for the individual objects define attributes and/or capabilities of the objects, and the object state information for the individual objects specify a position, a motion, and/or actions of the objects within the virtual space instance,
wherein the objects present in the virtual space instance include at least a first object and a second object,
wherein the objects are associated with object definitions, the object definitions including a streaming consideration reception profile for individual ones the objects, the streaming consideration reception profile including a consideration stream trigger definition, the consideration stream trigger definition specifying a circumstantial trigger, a consideration amount, and a consideration reception channel such that the first object is associated with a first object definition and the second object is associated with a second object definition;
facilitate presentation of a view of the virtual space instance to a user through a graphical user interface such that the objects are presented within the view of the virtual space instance in accordance with the obtained state space information;
obtain a first consideration provision channel associated with the first user;
monitor the state space information for circumstances in the virtual space instance that satisfy circumstantial triggers of consideration stream trigger definitions specified by the object definitions including the first object definition and the second object definition; and
responsive to detection of circumstances in the virtual space instance that satisfy the circumstantial triggers of the consideration stream trigger definitions, automatically and contemporaneously initiate streams of consideration amounts specified by the object definitions from the first consideration provision channel to consideration reception channels specified by the object definitions such that a first consideration amount is streamed to a first consideration reception channel as specified by the first object definition from the first consideration provision channel, and a second consideration amount is streamed to a second consideration reception channel as specified by the second object definition from the first consideration provision channel.

9. The system of claim 8, wherein a first consideration stream trigger definition associated with the first object includes a first distance value that specifies the proximity to the first object that facilitates initiating the stream of the first consideration amount upon occurrence.

10. The system of claim 8, wherein the first consideration reception channel includes a first digital wallet that corresponds to a first address on a decentralized ledger.

11. A method configured to facilitate virtual space instance access, the method comprising:
obtaining, in an ongoing manner, state space information defining a present state of a virtual space instance that includes a simulated 3-dimensional topography, objects positioned within the topography and capable of locomotion within the topography, and expresses ongoing real-time interaction by one or more users, the state space information including object definitions and object state information associated with the objects present in the virtual space instance, wherein the object definitions for the individual objects define attributes and/or capabilities of the objects, and the object state information for the individual objects specify a position, a motion, and/or actions of the objects within the virtual space instance,
wherein the objects present in the virtual space instance include a first object,
wherein the first object is associated with a first object definition, the first object definition including a first streaming consideration reception profile for the first object, the first streaming consideration reception profile including a first consideration stream trigger definition, the first consideration stream trigger definition specifying a first circumstantial trigger, a first consideration amount, and a first consideration reception channel;
facilitating presentation of a view of the virtual space instance to users through individual graphical user interfaces such that the objects are presented within the view of the virtual space instance in accordance with the obtained state space information;
obtaining consideration provision channels associated with the users, wherein the users include at least a first user and a second user, and a first consideration provision channel is associated with the first user and a second consideration provision channel is associated with the second user;
monitoring the state space information for circumstances in the virtual space instance that satisfy the first circumstantial trigger of the first consideration stream trigger definition; and
responsive to detection of circumstances in the virtual space instance that satisfy the first circumstantial trigger of the first consideration stream trigger definition, automatically initiating streams of the first consideration amount from the consideration provision channels associated with the users involved in the circumstances to the first consideration reception channel such that the first consideration amount is streamed from the first consideration provision channel and the second consideration provision channel to the first consideration reception channel.

12. The method of claim 11, wherein the first circumstantial trigger specifies one or more interactions with the object by the users that initiates the stream of the consideration amount upon occurrence.

13. The method of claim 12, wherein the one or more interactions include viewing the first object, a point of view of the user within the virtual space instance being in proximity to the first object, rotating the first object, displacing the first object, selecting the first object, and/or altering an appearance of the first object.

14. The method of claim 13, wherein the objects present in the virtual space instance include user-controlled objects that are controlled by the users, and wherein the one or more interactions with the first object are completed by the user-controlled objects.

15. The method of claim 11, wherein the first consideration provision channel includes a second digital wallet associated with the first user, and the second consideration provision channel includes a third digital wallet associated with the second user, wherein the second digital wallet corresponds to a second address on a decentralized ledger, and the third digital wallet corresponds to a third address on the decentralized ledger.

16. The method of claim 11, further comprising:
determining, based on the first consideration reception channel and the consideration provision channels, intermediate consideration channels that facilitates providing the first consideration amount from the consideration provision channels to the first consideration reception channel.

17. The method of claim 11, wherein the object definitions define one or more adjustments to the attributes and/or the capabilities responsive to unavailability of consideration as indicated by the consideration provision channels, further comprising:
determining whether the consideration provision channels are connected;
upon determination that the consideration provision channels are connected, determining whether the consideration provision channels indicate that consideration is available;
upon determination that the consideration provision channels are not connected or upon determination that the consideration is not available, determining the one or more adjustments to the attributes and/or the capabilities of the objects in accordance with the object definitions.

18. A method configured to facilitate virtual space instance access, the method comprising:
obtaining, in an ongoing manner, state space information defining a present state of a virtual space instance that includes a simulated 3-dimensional topography, objects positioned within the topography and capable of locomotion within the topography, and expresses ongoing real-time interaction by one or more users, the state space information including object definitions and object state information associated with the objects present in the virtual space instance, wherein the object definitions for the individual objects define attributes and/or capabilities of the objects, and the object state information for the individual objects specify a position, a motion, and/or actions of the objects within the virtual space instance,
wherein the objects present in the virtual space instance include at least a first object and a second object,
wherein the objects are associated with object definitions, the object definitions including a streaming consideration reception profile for individual ones the objects, the streaming consideration reception profile including a consideration stream trigger definition, the consideration stream trigger definition specifying a circumstantial trigger, a consideration amount, and a consideration reception channel such that the first object is associated with a first object definition and the second object is associated with a second object definition;
facilitating presentation of a view of the virtual space instance to a user through a graphical user interface such that the objects are presented within the view of the virtual space instance in accordance with the obtained state space information;
obtaining a first consideration provision channel associated with the first user;
monitoring the state space information for circumstances in the virtual space instance that satisfy circumstantial triggers of consideration stream trigger definitions specified by the object definitions including the first object definition and the second object definition; and
responsive to detection of circumstances in the virtual space instance that satisfy the circumstantial triggers of the consideration stream trigger definitions, automatically and contemporaneously initiating streams of consideration amounts specified by the object definitions from the first consideration provision channel to consideration reception channels specified by the object definitions such that a first consideration amount is streamed to a first consideration reception channel as specified by the first object definition from the first consideration provision channel, and a second consideration amount is streamed to a second consideration reception channel as specified by the second object definition from the first consideration provision channel.

19. The method of claim 18, wherein a first consideration stream trigger definition associated with the first object includes a first distance value that specifies the proximity to the first object that facilitates initiating the stream of the first consideration amount upon occurrence.

20. The method of claim 18, wherein the first consideration reception channel includes a first digital wallet that corresponds to a first address on a decentralized ledger.
